(19) United States
(12) Patent Application Publication
(10) Pub. No.: US 2026/0277868 A1
(43) Pub. Date: Sep. 17, 2026

(54) RESOURCE EFFICIENT VECTOR DATABASE SEARCHING IN PROMPTING OF LARGE LANGUAGE MODELS

(71) Applicant: SAP SE, Walldorf (DE)

(72) Inventor: Harsh Rao Dhanyamraju, Singapore (SG)

(21) Appl. No.: 19/079,577

(22) Filed: Mar. 14, 2025

(51) Int. Cl. G06F 16/22; G06F 16/245; G06F 16/93

(52) U.S. Cl. CPC G06F 16/2237; G06F 16/245; G06F 16/93

(57) ABSTRACT

Methods, systems, and computer-readable storage media for receiving a query, processing the query through a named entity recognition (NER) machine learning (ML) model to generate a set of entities, identifying, from a set of tuples of a vector database, a sub-set of tuples responsive to the set of entities, determining, from the sub-set of tuples, a sub-set of chunks responsive to the query, generating a prompt including the sub-set of tuples and at least a portion of the query, prompting a first LLM using the prompt to providing a LLM response, and returning a response to the query, the response including at least a portion of the LLM response.

### BACKGROUND

In the field of artificial intelligence (AI), so-called generative AI (GAI) has recently seen an explosion in popularity. GAI can be described as including so-called foundation models that generate content based on training data. For example, foundation models can include large language models (LLMs), which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of applying AI to use cases within enterprise platforms when compared to conventional machine learning (ML) models. However, integrating LLMs into enterprise platforms is a non-trivial task, as LLMs can present various technical challenges and can have disadvantages that have to be managed.

### SUMMARY

Implementations of the present disclosure are directed to a retrieval-augmented generation (RAG) for prompting large language models (LLMs) that implements a more sophisticated and effective method for managing and retrieving document chunks in high-dimensional vector spaces. More particularly, implementations of the present disclosure are directed to a multi-step approach to vector database searching, in which a search space is restricted based on one or more entities, and a sub-set of chunks are returned from searching within the search space. The sub-set of chunks is used for prompting a LLM.

In some implementations, actions include receiving a query, processing the query through a named entity recognition (NER) machine learning (ML) model to generate a set of entities, identifying, from a set of tuples of a vector database, a sub-set of tuples responsive to the set of entities, determining, from the sub-set of tuples, a sub-set of chunks responsive to the query, generating a prompt including the sub-set of tuples and at least a portion of the query, prompting a first LLM using the prompt to providing a LLM response, and returning a response to the query, the response including at least a portion of the LLM response. Other implementations of this aspect include corresponding systems, apparatus, and computer programs, configured to perform the actions of the methods, encoded on computer storage devices.

These and other implementations can each optionally include one or more of the following features: actions further include generating at least a portion of the set of tuples by splitting a document into a plurality of chunks, generating chunk embeddings based on the plurality of chunks, and for each chunk in the plurality of chunks, storing a tuple in the vector database, the tuple comprising at least one entity value, a chunk, and a chunk embedding; actions further include determining a context set for the document, the context set including the at least one entity value, and for each chunk, adding at least a portion of the context set to provide a contextualized chunk, each chunk embedding being generated by embedding the contextualized chunk; determining a context set for a document in a set of documents, the context set including at least one entity value includes processing the document using a second LLM to return the context set; splitting the document into chunks includes applying one or more regular expressions to content of the document; splitting the document into chunks includes providing each chunk as one or more rows of a table represented in the document; and at least one chunk includes a plurality of rows of the table.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIGS. 3A-3C depict example processes that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to a retrieval-augmented generation (RAG) for prompting large language models (LLMs) that implements a more sophisticated and effective method for managing and retrieving document chunks in high-dimensional vector spaces. More particularly, implementations of the present disclosure are directed to a multi-step approach to vector database searching, in which a search space is restricted based on one or more entities, and a sub-set of chunks are returned from searching within the search space. The sub-set of chunks is used for prompting a LLM.

Implementations can include actions of receiving a query, processing the query through a named entity recognition (NER) machine learning (ML) model to generate a set of entities, identifying, from a set of tuples of a vector database, a sub-set of tuples responsive to the set of entities, determining, from the sub-set of tuples, a sub-set of chunks responsive to the query, generating a prompt including the sub-set of tuples and at least a portion of the query, prompting a first LLM using the prompt to providing a LLM response, and returning a response to the query, the response including at least a portion of the LLM response.

Implementations of the present disclosure are described in further detail herein with non-limiting reference to example contexts. One example context includes documents that record agreements between enterprises, referred to herein as contracts. Another example context includes documents that record accounts receivable data of enterprises, referred to herein as accounts receivable documents. It is contemplated, however, that implementations of the present disclosure can be realized with any appropriate documents.

To provide further context for implementations of the present disclosure, and as introduced above, in the field of artificial intelligence (AI), so-called generative AI (GAI) has recently seen an explosion in popularity. GAI can be described as including so-called foundation models that generate content based on training data. For example, foundation models can include LLMs, which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of applying AI to use cases within enterprise platforms when compared to conventional machine learning (ML) models.

However, integrating LLMs into enterprise platforms is a non-trivial task. One reason for this is that LLMs can present various technical challenges and can have disadvantages that have to be managed. For example, the effectiveness and technical efficiency of an LLM is predominantly reliant on prompts, which are the input to the LLM. Well-constructed and detailed prompts enable the LLM to provide higher quality responses. However, prompts can be relatively complex for many enterprise-level use cases. For example, prompts can involve extensive directives, sophisticated instructions, and input data to provide context for the LLM.

However, LLMs are provisioned by third-party service providers (e.g., Mistral Large provided by Mistral AI) and are trained on training data from a broad spectrum of domains. In short, LLMs are not domain-specific and, as such, do not perform well when applied to particular domains. To alleviate this, techniques, such as RAG, have been developed to improve performance of LLMs with respect to particular domains. In general, RAG can include retrieving domain-specific data that is relevant to a prompt that is to be processed by a LLM, and using the domain-specific data as context within the prompt for prompting a LLM. In this manner, domain-related knowledge gaps of the LLM can be mitigated. More particularly, RAG operates by utilizing an embedding model to represent fragments of a document (e.g., also referred to as a chunks) as a point in a multi-dimensional vector space. These representations are commonly termed dense embeddings, with the vector space typically being a fixed dimension size of (e.g., approximately 300 to 700 dimensions). To identify relevant documents, a query received from a user, for example, is transformed into an embedding and a set of chunks is defined to include chunks determined to closely match the query based on respective similarity metrics (e.g., cosine similarity, L2-distance).

However, while RAG systems perform adequately with a limited number of documents, significant challenges arise with relatively large numbers of documents. In the example context of contracts, such documents often exhibit a high degree of similarity, with only minor details differing therebetween. For example, many contracts are based on a template that is majority static text. An example of this includes term redefinitions, such as specifying that buyer and seller refer to particular entities. Subsequent sections of the contracts then use these redefined terms rather than the company names. As a result, there is relatively minor differences between contracts and, thus, relatively minor differences between chunks. In the example context of accounts receivable documents, each document, typically in the form of a spreadsheet, contains numerous rows, resulting in the creation of hundreds of chunks per document. This is as compared to other documents, for which tens of chunks are typically generated.

In using RAG with such documents, the already dense vector space becomes more crowded, where multiple chunks cluster closely together. As a result, retrieval accuracy is severely diminished, leading to the retrieval of incorrect or irrelevant chunks that do not effectively address a query. In some cases, chunks can be retrieved, which inadvertently disclose confidential information. Further, a large number of chunks can be returned (both relevant and irrelevant) and including all of the chunks as context in prompts increases the size of the prompts. From a technical perspective, this presents multiple problems, such as exceeding token thresholds of prompts, increase consumption of technical resources as LLMs process larger prompts, and increased response time in LLMs returning responses.

In view of the above context, implementations of the present disclosure provide a RAG system that implements a more sophisticated and effective method for managing and retrieving document chunks in high-dimensional vector spaces. As described in further detail herein, implementations of the present disclosure prevent unnecessary clumping of chunks in the vector space, thereby enhancing the accuracy and relevance of chunk retrievals for documents, such as contracts and accounts receivable documents. In this manner, implementations of the present disclosure improve the performance, reliability, and technical efficiency in prompting of LLMs using RAG systems in large-scale document retrieval contexts for documents, such as contracts and accounts receivable data.

As described in further detail herein, implementations of the present disclosure provide significant improvements in search accuracy, robust handling of term redefinitions, and enhanced performance, resulting in a more technically efficient and scalable solution for document retrieval and analysis relative to traditional approaches. By combining these advantages, implementations of the present disclosure provide a more effective and reliable way to manage and retrieve complex data recorded in documents, which also leads to improved decision-making and outcomes.

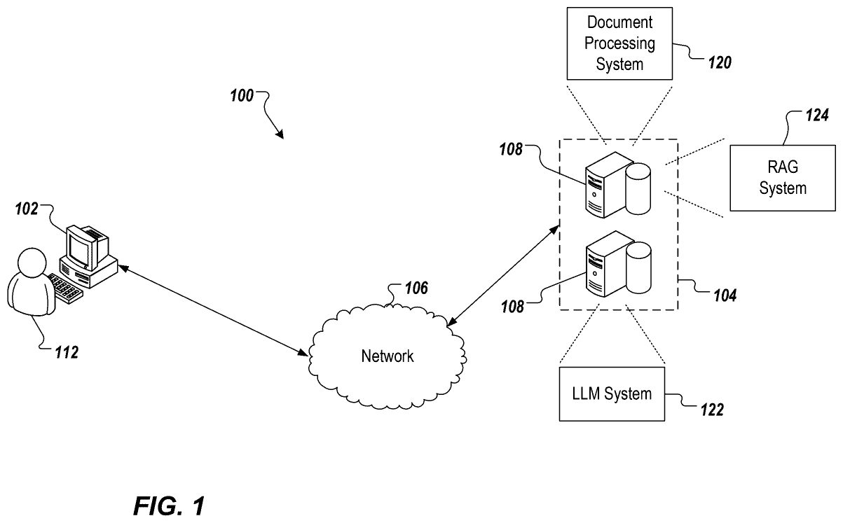

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, and as noted above, the server system 104 can host a document processing system 120 that leverages a LLM system 122 to process documents. For example, the document processing system 120 can receive queries from users (such as the user 112), which queries request information to be extracted from documents provided with the query. In some examples, the document processing system 120 prompts the LLM system 122 to extract the information from the documents. The document processing system 120 interacts with a RAG system 124 to provide sets of chunks based on documents in accordance with implementations of the present disclosure. The sets of chunks are provided as context data for prompts to the LLM system 122. Although the document processing system 120 and the RAG system 124 are depicted as separate systems in the example of FIG. 1, it is contemplated that the document processing system 120 and the RAG system 124 can be provided as a single system.

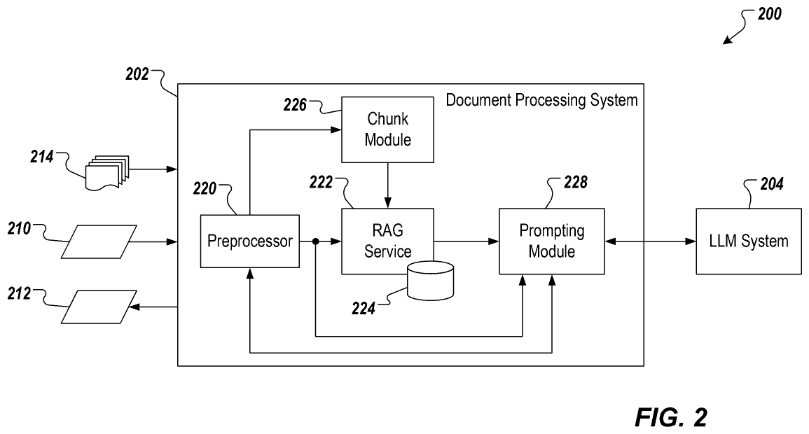

FIG. 2 depicts an example conceptual architecture 200 in accordance with implementations of the present disclosure. In the depicted example, the conceptual architecture 200 includes a document processing system 202 and a LLM system 204. In the example of FIG. 2, the document processing system 202 includes a preprocessor 220, a RAG service 222 with an associated vector database (DB) 224, a chunk module 226, and a prompting module 228. In some examples, the document processing system 202 includes a virtual agent (also referred to as a chatbot) that leverages the LLM system 204 to converse with the user in natural language. An example virtual agent can include Joule provided by SAP SE of Walldorf, Germany. For example, a user interface (UI) can be provided that the user can interact with to submit queries and, for some queries, documents to the document processing system 202. As described in further detail herein, during runtime (e.g., production use), the document processing system 202 receives, from a user, a query 210 and processes the query 210 to return a response 212. For example, the document processing system 202 prompts the LLM system 204, which returns a response, at least a portion of which can be included in the response 212.

During a design-time (e.g., prior to production use of the document processing system 202), the document processing system 202 processes documents 214 to populate the vector DB 224 with a set of tuples for each document 214. In some examples, a tuple can be described as a data set that includes a chunk, a set of entities associated with the chunk, and a chunk embedding. More particularly, in response to receiving a document 214, the preprocessor determines a type of the document. Example types can include, without limitation, a text document (e.g., .doc, .pdf) and a spreadsheet. For example, a text document can represent documents, such as contracts, and a spreadsheet can represent documents, such as an accounts receivable document. In some examples, the type of the document can be determined based on the file type indicated in the filename (e.g., .doc or .pdf indicates contract; .csv or .xls indicates accounts receivable document). In some examples, each document can be provided with an indicator that indicates the type.

In response to a document 214 being a first type (e.g., contract), the document 214 is provided to the chunk module 226 with instructions to split the document 214 into a set of chunks using a first chunking technique. In some examples, the first chunking technique includes splitting the document 214 into chunks based on sections represented in the document 214. In some examples, the first chunking technique includes using one or more regular expressions (regex) to split the document 214 into chunks. In general, a regex can be described as a sequency of characters that defines a pattern. In some examples, if a portion of the document 214 matches a regex, that portion is split out as a chunk. In the example context of contracts, an example of a regex can include:
/\n[A-Z\d]+[\.)][A-Z\d]*[\.)]?\s/
   The example regex can be used to check for sub-section headers (e.g., 1.2), 4.3)) in contracts to define chunks as sub-sections.

In some implementations, the document 214 is processed to extract information represented within the document 214. In the example context of contracts, the document 214 can be processed to extract contract details that include, but are not limited to customer (e.g., buyer) name, customer common name, effective data, expiring date, and additional parameters. In some implementations, the LLM system 204 is prompted to return a set of information for the document 214. For example, the preprocessor 220 can send a request to the prompting module 228 with the document 214 to prompt the LLM system 204 to process the document 214 and return the set of information. In the example context of contracts, an example prompt can be provided as:
You are an expert on contracts. You must extract import features from the contract. The important features are:
1) Customer Name—Full name of the customer used in the contract
2) Customer Common Name—A shorter version of the customer name, which would be used commonly in speech
3) Effective Date—The date from which the contract is effective in YYYY/MM
4) Expiring Date—The date at which the contract expires IN YYYY/MM
5) Additional Parameters—Any other terms that have been redefined or you feel are important

Listing 1: Example Prompt

```
Do not include <name-of-company-goes-here> as a customer.
Their involvement is implied.
You can find the contract data below:
“““
<Your-contract-first-page-goes-here>
”””
Your response must be in JSON form. With the following
template:
“““
{
  “Customer Name”: “<value>”,
  “Customer Common Name”: “<value>”,
  “Effective Date”: “<value>”,
  “Expiring Date”: “<value>”,
  “Additional Parameters”: {
    “<Param-1>”: “<Param-1-value>”,
    “<Param-2>”: “<Param-2-value>”,
    ...
}
”””
```

In response to the prompt, the LLM system 204 can return a response (e.g., in JSON format) that represents the set of information. In the example context of contracts, at least a portion of an example response can be provided as:

Listing 2: Portion of Example Response

```
{
  “Customer Name”: “ACME Technologies Co., Ltd.”,
  “Customer Common Name”: “ACME Tech”,
  “Effective Date”: “01.01.2026”,
  “Expiring Date”: “31.12.2031”,
  “Additional Parameters”: {
    “Monthly Payment”: “10,000”,
    “Cure Period”: “30”,
    “Delay Fee”: “2%”,
    ...
}
```

In some implementations, the response from the LLM system 204 is parsed using a parser (e.g., JSON parser) to provide a context set. For example, the preprocessor 220 can parse the response to provide the context set. In some examples, the parser can be described as a program that reads formatted text (e.g., text in JSON format) and converts the formatted text into a more easily usable data structure (e.g., dictionary, list, object). Continuing with the non-limiting examples above, an example context set can be provided as:

Listing 3: Example Context Set
[Customer Name, ACME Technologies Co., Ltd.]
[Customer Common Name, ACME Technologies]
[Effective Date, 01.01.2026]
[Expiring Date, 31.12.2031]
[Monthly Payment, 10,000]
[Cure Period, 30]
[Delay Fee, 2%]
...

In some examples, the parser can correct for errors that the LLM can make when giving formatted output (e.g., JSON output). Example errors can include adding a header (e.g., ′′′json) before the text, adding a statement before or after the output (e.g., Here is your json:, I was not able to find . . . ), and adding multiline strings, which are not supported. Using LLMs, such errors are often inconsistent and random in nature, but they are easy to fix with simple code. The parser will flag such errors for simple resolution.

In some implementations, values of one or more entities are extracted from the context set and are stored in an entity list. In the example context of contracts, an example entity can include customer name. In some examples, the value for customer name within the context set is stored in an entity list. Continuing with the non-limiting examples above, the value ACME Technologies Co., Ltd. can be stored in the entity list. In some examples, the entity list is maintained within the RAG service 222. For example, the preprocessor 220 can provide the context set to the RAG service 222, which extracts the values of the one or more entities and store the values in the entity list.

In some implementations, at least a portion of the context set is added to each chunk in the set of chunks provided for the document 214. In this manner, each chunk can be provided as a contextualized chunk. For example, at least a portion of the context set is appended to the beginning or the end of each chunk. Continuing with the non-limiting examples above, an example contextualized chunk can be provided as:

Listing 4: Example Contextualized Chunk
[ACME Technologies Co., Ltd. ACME Technologies 01.01.2026
31.12.2031 10,000 30 2% ... CHUNKTEXT]

In the example of Listing 4, the chunk includes CHUNKTEXT (e.g., the text of the document for the chunk) and the contextualized chunk is provided as the context set concatenated with the CHUNKTEXT at the beginning.

In some implementations, a set of chunk embeddings is generated for the set of contextualized chunks. In some examples, each contextualized chunk is processed through an embedder (e.g., a pre-trained ML model), which generates a chunk embedding for the contextualized chunk within an embedding space. For example, the RAG service 222 can process each contextualized chunk through the embedder to provide the chunk embeddings. Each chunk embedding is provided as a multi-dimensional numerical vector that represents a respective chunk.

In accordance with implementations of the present disclosure, a set of tuples for the document 214 are stored in the vector DB. In some examples, each tuple includes one or more entity values, a chunk embedding, and a chunk. For example, the one or more entity values can include entities extracted for the context set provided for the document 214, the chunk is one in the set of chunks determined for the document, and the chunk embedding is the embedding generated for the contextualized chunk determined for the chunk. Continuing with the non-limiting examples above, an example tuple can be provided as:

Listing 5: Example Tuple

[ACME Technologies Co., Ltd., CHUNKTEXTᵢ, Eᵢ]

In the example of Listing 5, ACME Technologies Co., Ltd. is the value of the entity extracted from the context set of the i^{th} chunk (Cᵢ) in a set of chunks (e.g., [C₁, . . . , Cₘ]) determined for the document 214, CHUNKTEXTᵢ is the text of Cᵢ, and Eᵢ is the chunk embedding for Cᵢ.

In response to a document 214 being a second type (e.g., spreadsheet), the document 214 is split into rows and each row is converted to a format (e.g., JSON format). For example, the document 214 can record a table that includes a set of columns representing data types and a set of rows, each row being a record of the table. By way of non-limiting example, and in the example context of accounts receivable documents, an example table can be provided as:

TABLE 1
Example Table

| Statement | Company | | | | |
|---|---|---|---|---|---|
| ID | Code | Amount | Currency | Customer Name | Note |
| 101 | CC2 | 405.78 | USD | ME Industries, Inc. | Inv. 433289 |
| 102 | CC50 | 750 | USD | Generic Company | Cont#A456-12 |
| | | | | Corp. | |
| 103 | CC50 | 675 | USD | Generic Company | Cont#A456-12 |
| | | | | Corp. | |
| . . . | . . . | . . . | . . . | . . . | . . . |
| 10001 | CC1 | 10,000 | USD | ACME | 139853 |
| | | | | Technologies Co., | |
| | | | | Ltd. | |

In view of the example of Table 1, an example conversion of a row to JSON format can be provided as:

Listing 6: Example Row Conversion

```
{
  “Statement ID”: “102”,
  “Company Code”: “CC50”,
  “Amount”: “750”,
  “Currency”: “USD”,
  “Customer Name”: “Generic Company Corp.”,
  “Note”: “ Cont#A456-12”,
    ...
}
```

In some examples, by converting rows to JSON format, the column names and values are provided for chunking. Otherwise, values would be provided without the column names. In this manner, each chunk makes sense individually, in the absence of any other chunk.

In some implementations, for each document 214 an indication is received that indicates a column that records values for a specific entity. For example, and with reference to the example of Table 1, an example entity can include customer name and the indication can indicate column 5 as recording values of customer name. In some examples, the indication can be provided with each document 214. In some examples, a request can be sent to a user to request that the user indicate, for a respective document 214, or all documents 214, which column that records values for a specific entity.

In some implementations, values of one or more entities are extracted from the rows and are stored in an entity list. In the example context of accounts receivable documents, an example entity can include customer name. In some examples, the values for customer names within the column that is indicated for the table is extracted. In some examples, only unique values are added to the entity list. Continuing with the non-limiting examples above, the value Generic Company Corp. can be stored in the entity list. However, the value Generic Company Corp. is stored only once in the entity list, although it appears multiple times in the example of Table 1. In some examples, the entity list is maintained within the RAG service 222. For example, the preprocessor 220 can provide the rows (e.g., in JSON format) to the RAG service 222, which extracts the values of the one or more entities and store the values in the entity list.

In some implementations, each row can be considered a chunk. In accordance with implementations of the present disclosure, two or more rows can be combined as a single chunk. In some examples, if contiguous rows include the same value for the entity, the rows can be combined as a single chunk. In some examples, while, going row by row through the dataset, a copy of the company code, for example, in the previous row is stored and, if the company code for the previous row and the current row match, the rows can be combined to provide a single chunk. This mitigates overcrowding in the vector space, as described herein. In some examples, a maximum number of rows (e.g., 2 or 3 rows) can be combined to provide a single chunk. In this manner, a core meaning of a chunk can be maintained. An example of a combined chunk would be:

Listing 7: Example of Combined Rows for Chunk

```
{
  “Statement ID”: “102”,
  “Company Code”: “CC50”,
  “Amount”: “750”,
  “Currency”: “USD”,
  “Customer Name”: “Generic Company Corp.”,
  “Note”: “ Cont#A456-12”,
    ...
}
{
  “Statement ID”: “105”,
  “Company Code”: “CC50”,
  “Amount”: “7856”,
  “Currency”: “EUR”,
  “Customer Name”: “Generic Company Corp.”,
  “Note”: “ Cont#A462-69”,
    ...
}
```

In some implementations, a set of chunk embeddings is generated for the set of chunks. In some examples, each chunk (e.g., row, combined rows) is processed through an embedder (e.g., a pre-trained ML model), which generates a chunk embedding for the chunk within an embedding space. For example, the RAG service 222 can process each chunk through the embedder to provide the chunk embeddings. Each chunk embedding is provided as a multi-dimensional numerical vector that represents a respective chunk.

In accordance with implementations of the present disclosure, a set of tuples for the document 214 are stored in the vector DB. In some examples, each tuple includes one or more entity values, a chunk embedding, and a chunk. For example, the one or more entity values can include entities extracted for the context set provided for the document 214, the chunk is one in the set of chunks determined for the document, and the chunk embedding is the embedding generated for the contextualized chunk determined for the chunk. Continuing with the non-limiting examples above, an example tuple can be provided as:

Listing 8: Example Tuple

[ACME Technologies Co., Ltd., CHUNKTEXTᵢ, Eᵢ]

In the example of Listing 8, ACME Technologies Co., Ltd. is the value of the entity extracted from the context set of the i^{th} chunk (Cᵢ) in a set of chunks (e.g., [C₁, . . . , Cₘ]) determined for the document 214, CHUNKTEXTᵢ is the text of Cᵢ, and Eᵢ is the chunk embedding for Cᵢ.

In accordance with implementations of the present disclosure, processing of the documents 214 during design-time results in the entity list being populated with values of entities determined from the documents 214 and the vector DB 224 being populated with sets of tuples, each set of tuples corresponding to a respective document. Continuing with the non-limiting examples above, an example entity list and example tuples stored in the vector DB 224 can be respectively provided as:

Listing 9: Example Entity List
ACME Technologies Co., Ltd.
ME Industries, Inc.
...
Generic Company Corp.

Listing 10: Example Tuples
[ACME Technologies Co., Ltd., CHUNKTEXT_{1,1}, E_{1,1}]
[ACME Technologies Co., Ltd., CHUNKTEXT_{1,2}, E_{1,2}]
...
[ACME Technologies Co., Ltd., CHUNKTEXT_{1,13}, E_{1,13}]
[ME Industries, Inc., CHUNKTEXT_{2,1}, E_{2,1}]
[ME Industries, Inc., CHUNKTEXT_{2,2}, E_{2,2}]
...
[ME Industries, Inc., CHUNKTEXT_{3,1}, E_{3,10}]
...
[Generic Company Corp., CHUNKTEXT_{50,1}, E_{50,1}]
[Generic Company Corp., CHUNKTEXT_{50,2}, E_{50,2}]
...
[Generic Company Corp., CHUNKTEXT_{50,1}, E_{50,14}]

In the examples of Listings 9 and 10, ACME Technologies Co., Ltd., ME Industries, Inc., and Generic Company Corp. are example (fictional) entities in an entity list (e.g., that includes 50 entities), where a set of chunks (e.g., [C₁, . . . , C₁₃]₁) is determined to for ACME Technologies Co., Ltd., a set of chunks (e.g., [C₁, . . . ) C₃₀]₂) is determined to for ME Industries, Inc., and a set of chunks (e.g., [C₁, . . . , C₁₄]₅₀) is determined to for Generic Company Corp. In this example, the set of chunks (e.g., [C₁, . . . , C₃₀]₂) determined to for ME Industries, Inc. is larger than those of the other set of chunks. In the example context of contracts, this can result from, for example, multiple documents 214 being associated with ME Industries, Inc., while fewer documents 214 are associated with each of ACME Technologies Co., Ltd. and Generic Company Corp. In the example context of accounts receivable documents, this can result from, for example, multiple non-contiguous rows being associated with ME Industries, Inc., while fewer rows are associated with each of ACME Technologies Co., Ltd. and Generic Company Corp.

During the runtime, the preprocessor 220 processes the query 210 to determine a set of entities that are relevant to the query 210. In some examples, the RAG service 222 searches the vector DB 224 to identify a set of chunks that are relevant to the query 210. More particularly, in response to receiving the query 210, the query 210 is processed (e.g., by the preprocessor 220) to determined a set of named entities from the query 210. In some examples, the query 210 is input to a named entity recognition (NER) model (e.g., a pre-trained ML model) that determines the set of entities. Example queries can include:
What is payment history of ACME Technologies ? Do they have a record of paying their dues on time ?
What does the termination clause of the contract with Generic Company Corp say ?
Generic Company Corp is asking for an extension of the deadline to make their payment. What does their contract say about this?

In some implementations, each named entity is compared to the entities recorded in the entity list to provide a set of entity similarity scores, each entity similarity score representing a degree of similarity between the named entity and an entity included in the entity list. In some examples, each entity similarity score is calculated as a Levenshtein distance, which can be described as the minimum number of single-character edits (insertions, deletions, substitutions) required to change one entity into another entity. Although Levenshtein distance is discussed herein, it is contemplated that implementations of the present disclosure can be realized using any appropriate similarity scoring technique.

In some implementations, each entity similarity score can be compared to a threshold entity similarity score to determine whether an entity value from the entity list is to be used for further processing. For example, if an entity similarity score is not greater than the threshold entity similarity score, the respective entity value from the entity list can be used for further processing. By way of non-limiting example, an example query can include an entity ACME Technologies and an entity Yesterday's Tech Tomorrow that are extracted from the query using NER. In some examples, each can be compared to entity values in the entity list to generate entity similarity scores. Example entity similarity scores (S_{i,j}) can be provided as:

TABLE 2
Example Similarity Scores
ACME Technologies

| | |
|---|---|
| ACME Technologies Co., Ltd. | S_{1, 1} |
| ME Industries, Inc. | S_{1, 2} |
| . . . | . . . |
| Generic Company Corp. | S_{1, 50} |

TABLE 3
Example Similarity Scores
Yesterday's Tech Tomorrow

| | |
|---|---|
| ACME Technologies Co., Ltd. | S_{2, 1} |
| ME Industries, Inc. | S_{2, 2} |
| . . . | . . . |
| Generic Company Corp. | S_{2, 50} |

In the examples of Tables 2 and 3, it can be determined that only S_{1,1} is below the threshold entity similarity score. Consequently, the value ACME Technologies Co., Ltd. is added to an entity set for further processing as described herein.

In accordance with implementations of the present disclosure, a query embedding is generated for the query 210. In some examples, the query 210 is processed through an embedder (e.g., a pre-trained ML model), which generates a query embedding for the query 210 within an embedding space. For example, the RAG service 222 can process the query 210 through the embedder to provide the query embedding. The query embedding is provided as a multi-dimensional numerical vector that represents the query. In some examples, the query embedding is generated using the same embedder that is used to generate the chunk embeddings. In this manner, the query 210 is embedded in the same embedding space as the chunks.

In accordance with implementations of the present disclosure, one or more sub-sets of tuples of the vector DB 224 is defined based on entities in the entity set determined based on entity similarity scores, as discussed above. For example, for each entity in the entity set, a sub-set of tuples is defined to include tuples within the vector DB 224 that is associated with that entity. Continuing with the non-limiting examples above, the entity set can include ACME Technologies Co., Ltd. and, as a result, the following sub-set of tuples is provided:

Listing 11: Example Sub-Set of Tuples
[ACME Technologies Co., Ltd., CHUNKTEXT_{1,1}, E_{1,1}]
[ACME Technologies Co., Ltd., CHUNKTEXT_{1,2}, E_{1,2}]
...
[ACME Technologies Co., Ltd., CHUNKTEXT_{1,13}, E_{1,13}]

Here, the sub-set of tuples includes (significantly) fewer tuples than stored in the vector DB 224.

In accordance with implementations of the present disclosure, the query embedding can be compared to each chunk embedding of the sub-set of tuples to determine a set of embedding similarity scores, each embedding similarity score representing a degree of similarity between the query embedding and a respective chunk embedding. In some examples, the embedding similarity scores can be calculated as a cosine distance between the query embedding and the chunk embeddings. For example, an embedding similarity score can be calculated as the cosine of the angle between the query embedding and a chunk embedding (both being vectors) (e.g., as the dot product of the vectors divided by the product of length of the vectors). Each embedding similarity score is in a range [−1, 1], where two proportional embeddings have an embedding similarity score of 1, two orthogonal embeddings have an embedding similarity score of 0, and two opposite embeddings have an embedding similarity score of −1. In some examples, the embedding similarity scores are bounded to a range [0, 1] (e.g., embedding similarity scores that are less than 0 are set equal to 0).

Continuing with the non-limiting examples above, the following example embedding similarity scores can be provided:

TABLE 4
Example Embedding Similarity Scores

| | | |
|---|---|---|
| E_{Q} | E_{1, 1} | S_{E, 1} |
| | E_{1, 2} | S_{E, 2} |
| | E_{1, 3} | S_{E, 3} |
| | . . . | . . . |
| | E_{1, 13} | S_{E, 13} |

In the example of Table 4, EQ is the query embedding (of the query 210) and a set of embedding similarity scores (e.g., [S_{E,1}, . . . , S_{E,13}]) is determined.

In some implementations, each embedding similarity score can be compared to a threshold embedding similarity score to determine a sub-set of chunks that are to be used for further processing, as described herein. In some examples, if an embedding similarity score meets or exceeds the threshold embedding similarity score, the chunk associated with the chunk embedding underlying the embedding similarity score is included in the sub-set of chunks. Continuing with the non-limiting examples above, it can be determined that the embedding similarity scores S_{E,2}, S_{E,5}, S_{E,8}, and S_{E,13} each meets or exceeds the threshold embedding similarity score. Consequently, the chunks CHUNKTEXT_{1,2}, CHUNKTEXT_{1,5}, CHUNKTEXT_{1,8}, and CHUNKTEXT_{1,13} are each included in the sub-set of chunks.

In some implementations, the prompting module 228 generates a prompt based on the query 210 and the sub-set of chunks. Here, the chunks in the sub-set of chunks provide context for the LLM system 204 when processing the prompt. In some examples, the prompt is generated using a prompt template. In some examples, the prompt template includes static content and placeholders, where static content includes content (e.g., text) that is the same for every prompt that is generated using the prompt template, and placeholders can be populated with content (e.g., text, file names, URLs) that is specific to a particular prompt. For example, one or more placeholders can be populated with the query 210 or portions of the query 210 and a placeholder can be populated with chunks in the sub-set of chunks (or a URL to the chunks). An example prompt can be provided as:
You are Cashy, an assistant for senior management in a company. You are an expert in dealing with contracts & accounts receivable. You must help company executives by answering all their questions. You will be given snippets of the contracts and accounts receivable data as required you must understand them and answer any questions asked. Do not forget to include the links to the documents you referred to at the end of your answer. If you do not have the information needed to answer the question, please provide best answer you can give with the information available. Do not make up information under any circumstances!

Listing 12: Example Prompt

```
Contracts Information:
‘‘‘
<relevant-chunks-of-contracts-here>
‘‘‘
Accounts Receivable Data:
‘‘‘
<relevant-chunks-of-accounts-here>
‘‘‘
User's Question is:
‘‘‘
<user-question-here>
‘‘‘
Give your answer in the following JSON format:
  {
    ″response″: <your response>,
    ″references″: [
      {
        ″name″: <filename of referenced document>,
        ″url″: <url of referenced document>
      }
    ]
  }
```

In some examples, a response is received from the LLM system 204, at least a portion of which can be included in the response 212.

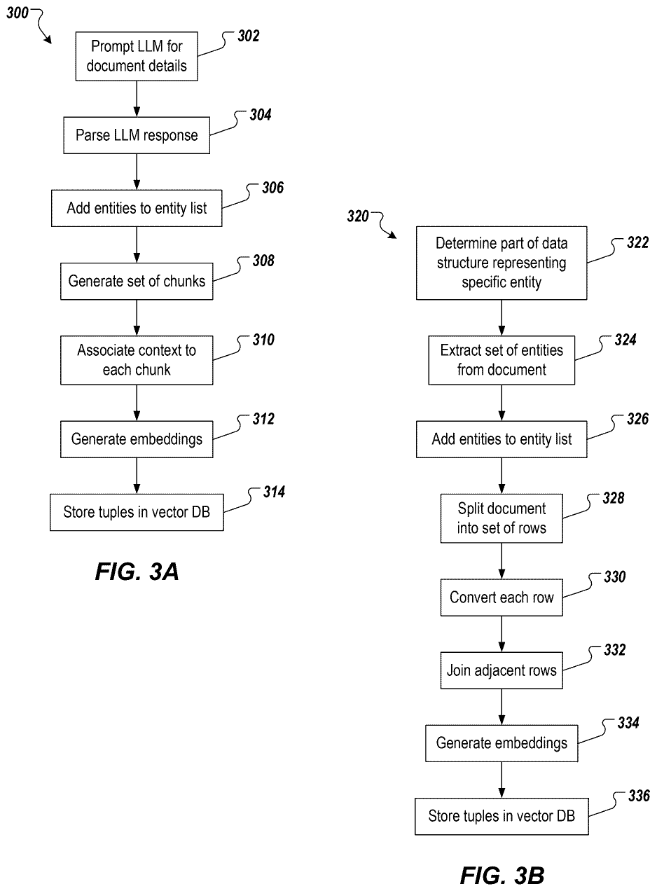

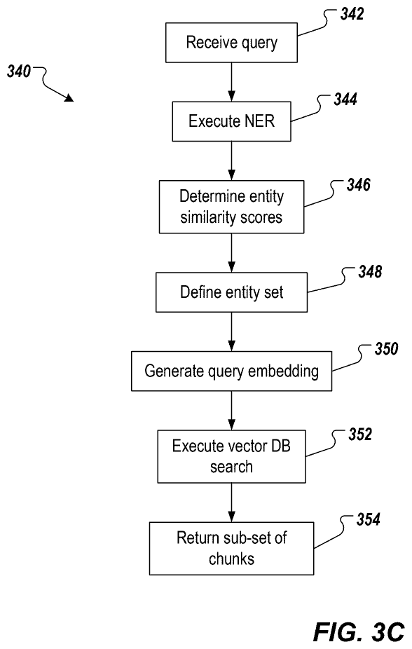

FIG. 3A depicts an example process 300 that can be executed in accordance with implementations of the present disclosure. In some examples, the example process 300 is provided using one or more computer-executable programs executed by one or more computing devices. In some examples, the example process 300 is executed during a design-time to process documents of a first type (e.g., .doc, .pdf).

A LLM is prompted for document details (302) and the LLM response is parsed (304). For example, and as described in detail herein, the LLM system 204 is prompted to return a set of information for the document 214. For example, the preprocessor 220 can send a request to the prompting module 228 with the document 214 to prompt the LLM system 204 to process the document 214 and return the set of information. In response to the prompt, the LLM system 204 can return a response (e.g., in JSON format) that represents the set of information. In some implementations, the response from the LLM system 204 is parsed using a parser (e.g., JSON parser) to provide a context set. For example, the preprocessor 220 can parse the response to provide the context set. One or more entities are added to an entity list (306). For example, and as described in detail herein, values of one or more entities are extracted from the context set and are stored in an entity list.

A set of chunks is generated (308) and context is associated with each chunk (310). For example, and as described in detail herein, the document 214 is provided to the chunk module 226 with instructions to split the document 214 into a set of chunks using a first chunking technique. In some examples, the first chunking technique includes using one or more regular expressions (regex) to split the document 214 into chunks. Chunk embeddings are generated (312) and tuples are stored in a vector DB (314). For example, and as described in detail herein, at least a portion of the context set is added to each chunk in the set of chunks provided for the document 214. In this manner, each chunk can be provided as a contextualized chunk. A set of chunk embeddings is generated for the set of contextualized chunks. In some examples, each contextualized chunk is processed through an embedder (e.g., a pre-trained ML model), which generates a chunk embedding for the contextualized chunk within an embedding space. A set of tuples for the document 214 is stored in the vector DB. In some examples, each tuple includes one or more entity values, a chunk embedding, and a chunk.

FIG. 3B depicts an example process 320 that can be executed in accordance with implementations of the present disclosure. In some examples, the example process 320 is provided using one or more computer-executable programs executed by one or more computing devices. In some examples, the example process 320 is executed during a design-time to process documents of a second type (e.g., .csv, .xls).

A part of a data structure that represents values of a specific entity is determined (322). For example, and as described in detail herein, for each document 214 an indication is received that indicates a column that records values for a specific entity. In some examples, the indication can be provided with each document 214. In some examples, a request can be sent to a user to request that the user indicate, for a respective document 214, or all documents 214, which column that records values for a specific entity.

A set of entities is extracted from the document (324) and is added to an entity list (326). For example, and as described in detail herein, values of one or more entities are extracted from the rows and are stored in an entity list. In the example context of accounts receivable documents, an example entity can include customer name. In some examples, the values for customer names within the column that is indicated for the table is extracted. In some examples, only unique values are added to the entity list.

The document is split into rows (328) and each row is converted (330). For example, and as described in detail herein, each row can be considered a chunk and each row is converted to a format (e.g., JSON format). Two or more adjacent rows are joined (332). For example, and as described in detail herein, two or more rows can be combined as a single chunk. In some examples, if contiguous rows include the same value for the entity, the rows can be combined as a single chunk. Chunk embeddings are generated (334) and tuples are stored in a vector DB (336). For example, and as described in detail herein, a set of chunk embeddings is generated for the set of chunks. In some examples, each chunk (e.g., row, combined rows) is processed through an embedder (e.g., a pre-trained ML model), which generates a chunk embedding for the chunk within an embedding space. A set of tuples for the document 214 are stored in the vector DB 224.

FIG. 3C depicts an example process 340 that can be executed in accordance with implementations of the present disclosure. In some examples, the example process 340 is provided using one or more computer-executable programs executed by one or more computing devices. In some examples, the example process 340 is executed during a runtime for vector DB searching to generate prompts for prompting LLMs.

A query is received (342) and NER is executed (344). For example, and as described in detail herein, in response to receiving the query 210, the query 210 is processed (e.g., by the preprocessor 220) to determined a set of named entities from the query 210. In some examples, the query 210 is input to a named entity recognition (NER) model (e.g., a pre-trained ML model) that determines the set of entities. Entity scores are determined (346) and an entity set is defined (348). For example, and as described in detail herein, each named entity is compared to the entities recorded in the entity list to provide a set of entity similarity scores, each entity similarity score representing a degree of similarity between the named entity and an entity included in the entity list. Each entity similarity score can be compared to a threshold entity similarity score to determine whether an entity value from the entity list is to be used for further processing in the entity set.

A query embedding is generated and a vector DB search is executed (352) and a sub-set of chunks is returned (354). For example, and as described in detail herein, one or more sub-sets of tuples of the vector DB 224 is defined based on entities in the entity set determined based on entity similarity scores. A query embedding is generated for the query and the query embedding can be compared to each chunk embedding of the sub-set of tuples to determine a set of embedding similarity scores, each embedding similarity score representing a degree of similarity between the query embedding and a respective chunk embedding. Each embedding similarity score can be compared to a threshold embedding similarity score to determine a sub-set of chunks that are to be used for further processing, as described herein.

Implementations of the present disclosure provide multiple technical improvements. For example, as described herein, implementations of the present disclosure restrict the search space within the vector DB to a limited set of entities. As a result, the issue of crowding in the vector space is mitigated and chunks that most accurately match the query are retrieved. This also results in enhanced accuracy that scales better with increasing document volumes, relative to traditional approaches. Further, and in the example context of contracts, robust handling of term redefinitions is provided. For example, the incorporation of an LLM call prior to inserting documents into the vector DB effectively addresses term redefinitions in contracts. By defining terms within each chunk, implementations of the present disclosure ensure that all chunks possess relevant context, yielding more accurate chunk embeddings and improved retrieval outcomes. Furthermore, this contextual information can be leveraged by the LLM to enhance the final answer.

Implementations of the present disclosure also provide improvements in terms of improving efficiencies in consumption of technical resources. For example, a comparative analysis of time complexities reveals that the implementations of the present disclosure offer significant performance advantages over traditional approaches. Specifically, the time complexity of a vector DB search is O(nd), where n represents the number of chunks and d denotes the number of dimensions (e.g., typically ranging from 300 to 700). In contrast, the time complexity of the entity similarity search (e.g., based on Levenshtein distance) is O(ns²), where n is the number of entities and s is the average number of characters in entity values. Although d and s² are similar in magnitude (with typical values for d and s ranging from 300-700 and 18-25, respectively), the number of chunks vastly exceeds the number of entities, as each entity typically has multiple chunks associated therewith (e.g., multiple contracts, multiple records in accounts receivable). Consequently, the multi-stage search approach of the present disclosure combines entity similarity search with a filtered vector DB search, to yield significantly faster query times and reduced consumption of technical resources, as compared to a full vector DB search. Notably, this performance advantage becomes increasingly pronounced as the number of entities and documents grows.

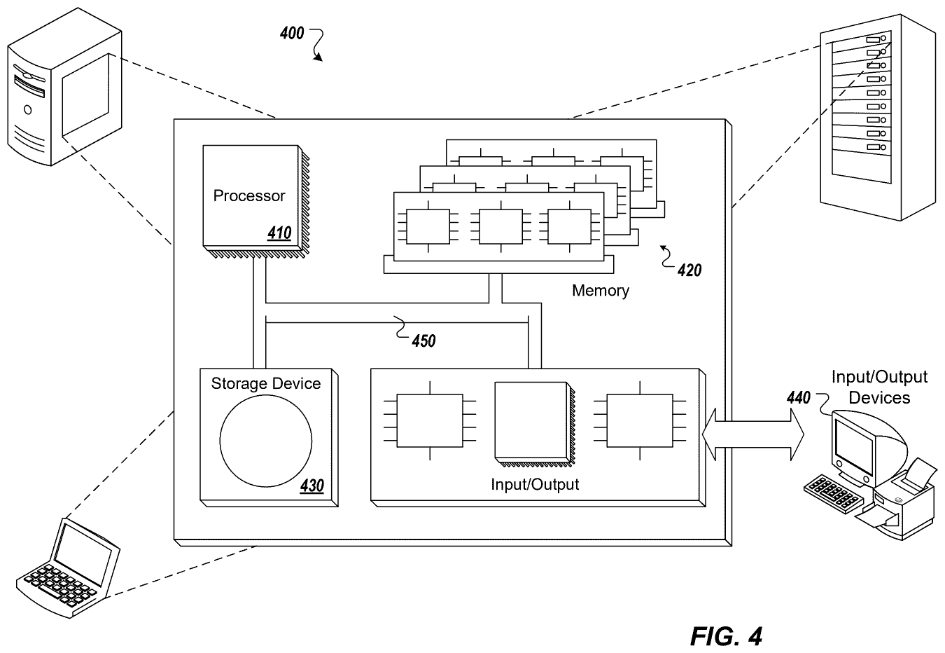

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method for vector DB searching to generate prompts for prompting large language models (LLMs), the method being executed by one or more processors and comprising:
receiving a query;
processing the query through a named entity recognition (NER) machine learning (ML) model to generate a set of entities from an entity list, the entity list being generated by extracting one or more entities from a context set and storing the one or more entities in the entity list;
identifying, from a set of tuples of a vector database, a sub-set of tuples responsive to the set of entities;
determining, from the sub-set of tuples, a sub-set of chunks responsive to the query;
generating a prompt comprising the sub-set of tuples and at least a portion of the query;
prompting a first LLM using the prompt to provide an LLM response; and
returning a response to the query, the response comprising at least a portion of the LLM response.

2. The method of claim 1, further comprising generating at least a portion of the set of tuples by:
splitting a document into a plurality of chunks;
generating chunk embeddings based on the plurality of chunks; and
for each chunk in the plurality of chunks, storing a tuple in the vector database, the tuple comprising at least one entity value, a chunk, and a chunk embedding.

3. The method of claim 2, further comprising:
determining a context set for the document, the context set comprising the at least one entity value; and
for each chunk, adding at least a portion of the context set to provide a contextualized chunk, each chunk embedding being generated by embedding the contextualized chunk.

4. The method of claim 3, wherein determining a context set for a document in a set of documents, the context set comprising at least one entity value comprises processing the document using a second LLM to return the context set.

5. The method of claim 2, wherein splitting the document into chunks comprises applying one or more regular expressions to content of the document.

6. The method of claim 2, wherein splitting the document into chunks comprises providing each chunk as one or more rows of a table represented in the document.

7. The method of claim 6, wherein at least one chunk comprises a plurality of rows of the table.

8. A non-transitory computer-readable storage medium coupled to one or more processors and having instructions stored thereon which, when executed by the one or more processors, cause the one or more processors to perform operations for vector DB searching to generate prompts for prompting large language models (LLMs), the operations comprising:
receiving a query;
processing the query through a named entity recognition (NER) machine learning (ML) model to generate a set of entities from an entity list, the entity list being generated by extracting one or more entities from a context set and storing the one or more entities in the entity list;
identifying, from a set of tuples of a vector database, a sub-set of tuples responsive to the set of entities;
determining, from the sub-set of tuples, a sub-set of chunks responsive to the query;
generating a prompt comprising the sub-set of tuples and at least a portion of the query;
prompting a first LLM using the prompt to provide an LLM response; and
returning a response to the query, the response comprising at least a portion of the LLM response.

9. The non-transitory computer-readable storage medium of claim 8, wherein operations further comprise generating at least a portion of the set of tuples by:
splitting a document into a plurality of chunks;
generating chunk embeddings based on the plurality of chunks; and
for each chunk in the plurality of chunks, storing a tuple in the vector database, the tuple comprising at least one entity value, a chunk, and a chunk embedding.

10. The non-transitory computer-readable storage medium of claim 9, wherein operations further comprise:
determining a context set for the document, the context set comprising the at least one entity value; and
for each chunk, adding at least a portion of the context set to provide a contextualized chunk, each chunk embedding being generated by embedding the contextualized chunk.

11. The non-transitory computer-readable storage medium of claim 10, wherein determining a context set for a document in a set of documents, the context set comprising at least one entity value comprises processing the document using a second LLM to return the context set.

12. The non-transitory computer-readable storage medium of claim 9, wherein splitting the document into chunks comprises applying one or more regular expressions to content of the document.

13. The non-transitory computer-readable storage medium of claim 8, wherein splitting the document into chunks comprises providing each chunk as one or more rows of a table represented in the document.

14. The non-transitory computer-readable storage medium of claim 13, wherein at least one chunk comprises a plurality of rows of the table.

15. A system, comprising:
a computing device; and
a computer-readable storage device coupled to the computing device and having instructions stored thereon which, when executed by the computing device, cause the computing device to perform operations for vector DB searching to generate prompts for prompting large language models (LLMs), the operations comprising:
receiving a query;
processing the query through a named entity recognition (NER) machine learning (ML) model to generate a set of entities from an entity list, the entity list being generated by extracting one or more entities from a context set and storing the one or more entities in the entity list;
identifying, from a set of tuples of a vector database, a sub-set of tuples responsive to the set of entities;
determining, from the sub-set of tuples, a sub-set of chunks responsive to the query;
generating a prompt comprising the sub-set of tuples and at least a portion of the query;
prompting a first LLM using the prompt to provide an LLM response; and
returning a response to the query, the response comprising at least a portion of the LLM response.

16. The system of claim 15, wherein operations further comprise generating at least a portion of the set of tuples by:
splitting a document into a plurality of chunks;
generating chunk embeddings based on the plurality of chunks; and
for each chunk in the plurality of chunks, storing a tuple in the vector database, the tuple comprising at least one entity value, a chunk, and a chunk embedding.

17. The system of claim 15, wherein operations further comprise:
determining a context set for the document, the context set comprising the at least one entity value; and
for each chunk, adding at least a portion of the context set to provide a contextualized chunk, each chunk embedding being generated by embedding the contextualized chunk.

18. The system of claim 17, wherein determining a context set for a document in a set of documents, the context set comprising at least one entity value comprises processing the document using a second LLM to return the context set.

19. The system of claim 16, wherein splitting the document into chunks comprises applying one or more regular expressions to content of the document.

20. The system of claim 15, wherein splitting the document into chunks comprises providing each chunk as one or more rows of a table represented in the document.
